(19) United States
(12) Patent Application Publication
(10) Pub. No.: US 2025/0306670 A1
(43) Pub. Date: Oct. 2, 2025

(54) PROPOSAL DEVICE AND PROPOSAL METHOD

(71) Applicant: SONY GROUP CORPORATION, TOKYO (JP)

(72) Inventors: YUHEI TAKI, TOKYO (JP); KUNIHITO SAWAI, TOKYO (JP); MASAKI TAKASE, TOKYO (JP); AKIRA MIYASHITA, TOKYO (JP)

(21) Appl. No.: 18/864,888

(22) PCT Filed: May 10, 2023
(86) PCT No.: PCT/JP2023/017573

§ 371 Date: Nov. 12, 2024

(30) Foreign Application Priority Data
May 19, 2022 (JP) 2022-082360

(51) Int. Cl. G06F 3/01; G06F 11/34

(52) U.S. Cl. CPC G06F 3/01; G06F 11/3438; G06F 2201/86

(57) ABSTRACT

A proposal device (100) according to an embodiment of the present disclosure includes an acquisition unit (131) configured to acquire a first command input by a user to an information processing system, and a proposal unit (132) configured to propose, in a case where the first command is acquired by the acquisition unit, use of a second command using an input means different from the first command to the user based on a usage history of the user for the information processing system. The proposal unit determines whether or not to propose the use of the second command to the user based on a usage history of the user regarding processing executed by the first command or the second command.

### FIELD

The present disclosure relates to a proposal device and a proposal method for proposing a highly convenient input means to a user.

### BACKGROUND

With the development of information processing technologies, opportunities for users to utilize information devices including information processing systems are increasing. In addition, with the development of technology, when the user inputs some sort of command or information to the information processing system, it is possible to use not only an input device such as a keyboard or a mouse but also various input means such as voice input or gesture input.

In this regard, there has been proposed a technique for teaching a user a simpler input means in a case where a system includes a relatively simpler input means to input predetermined information.

### CITATION LIST

### Patent Literature

Patent Literature 1: JP 2001-216129 A

### SUMMARY

### Technical Problem

According to the prior art, since the user is taught that voice input is available instead of button operation, the information processing system can be more smoothly utilized.

However, with the diversification of users who use the information processing system and the complication of the system, it may occur a situation in which a preferred input means is different for each user or an appropriate input means is different depending on an application in the system. For example, even if another input means has a small input process, when such an input means is taught by the system, there is a possibility that some users find the teaching bothersome. On the other hand, in a system in which update is periodically performed, even if a more convenient input means is added, it is difficult for a user who has already used the system to notice the addition. In this case, the user loses an opportunity to use the more useful input means in spite of the presence of the more useful input means.

As described above, in the information processing system, there is a problem that the unnecessary teaching of the input means is frequently performed, thereby deteriorating the comfort of the user, and on the other hand, the convenient input means is not sufficiently utilized.

Therefore, the present disclosure proposes a proposal device and a proposal method capable of appropriately teaching a user an input means having high utility value for the user.

### Solution to Problem

In order to solve the above problems, the proposal device according to an embodiment of the present disclosure includes an acquisition unit configured to acquire a first command input by a user to an information processing system, and a proposal unit configured to propose, in a case where the first command is acquired by the acquisition unit, use of a second command using an input means different from the first command to the user based on a usage history of the user for the information processing system.

### BRIEF DESCRIPTION OF DRAWINGS

FIG. 1 is a diagram illustrating an overview of proposal processing according to an embodiment.

FIG. 2 is a diagram (1) for explaining the proposal processing according to an embodiment.

FIG. 3 is a diagram (2) for explaining the proposal processing according to an embodiment.

FIG. 4 is a diagram illustrating a configuration example of a proposal device according to an embodiment.

FIG. 5 is a diagram illustrating an example of a proposal condition storage unit according to an embodiment.

FIG. 6 is a flowchart illustrating an example of a procedure of the proposal processing according to an embodiment.

FIG. 7 is a diagram conceptually illustrating a frequency of proposal processing according to an embodiment.

FIG. 8 is a diagram (1) illustrating a variation of proposal processing according to an embodiment.

FIG. 9 is a diagram (2) illustrating a variation of proposal processing according to an embodiment.

FIG. 10 is a diagram (3) illustrating a variation of proposal processing according to an embodiment.

FIG. 11 is a diagram (4) illustrating a variation of proposal processing according to an embodiment.

FIG. 12 is a hardware configuration diagram illustrating an example of a computer that implements functions of a proposal device.

### DESCRIPTION OF EMBODIMENTS

Hereinafter, embodiments will be described in detail with reference to the drawings. In each of the following embodiments, the same parts are denoted by the same reference numerals, and redundant description will be omitted.

The present disclosure will be described according to the following order of items.

1. Embodiment
1-1. Overview of Proposal Processing According to Embodiment
1-2. Configuration of Proposal Device According to Embodiment
1-3. Modifications
   1-3-1. Device Configuration
   1-3-2. Input to System
   1-3-3. System Aspects

2. Other Embodiments

3. Effects of Proposal Device According to Present Disclosure

4. Hardware Configuration

### 1. Embodiment

### (1-1. Overview of Proposal Processing According to Embodiment)

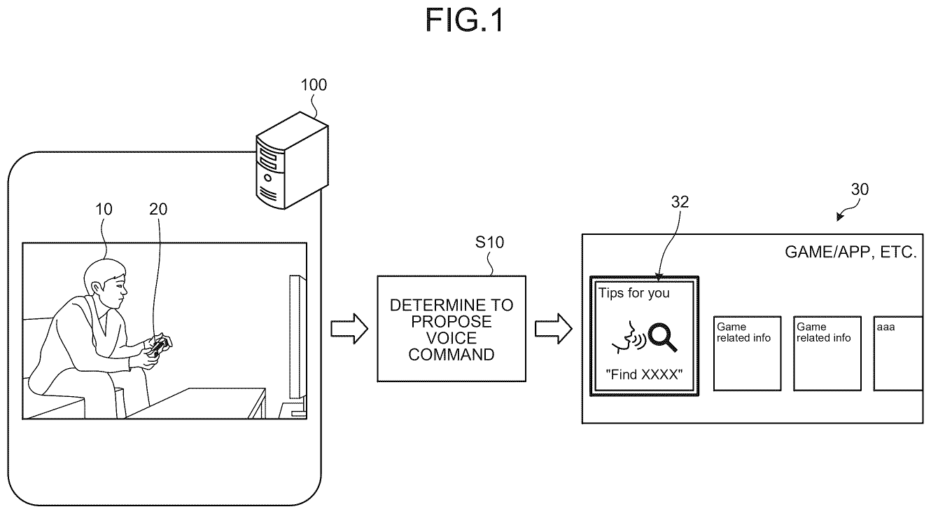

FIG. 1 is a diagram illustrating an overview of proposal processing according to an embodiment. The proposal processing according to the embodiment is implemented by a proposal device 100 illustrated in FIG. 1.

The proposal device 100 is an example of an information processing device that executes proposal processing according to the embodiment. For example, the proposal device 100 is a cloud server, a personal computer (PC), a smartphone, a tablet terminal, or the like connected to a network. Note that the proposal device 100 may be a smart home appliance such as a television, a wearable device such as a smart watch, a video game console such as a game machine, or the like as long as it is a device having a function to be described later. In the example of FIG. 1, the proposal device 100 is an information processing device including a voice agent capable of performing voice interaction with a user 10, and is capable of displaying various types of information on a connected display.

The user 10 is a user who uses the information processing system (hereinafter, simply referred to as the “system”) provided by the proposal device 100. The system provided by the proposal device 100 has, for example, a function as a so-called operating system (OS) that operates an installed game app, video viewing app, or the like, and controls message transmission to other users and a chat function. The user 10 can input various commands (referred to as “commands” or the like) to the system using a controller 20 which is an example of an input device. For example, the user 10 can operate the controller 20 to search for a friend (friend user) connected to the network or to search for a video to be viewed. In the following description, a user who mainly inputs a command to the proposal device 100 is referred to as the “user 10”, and is distinguished from other users (friends) connected to the user 10 via a network.

In recent years, with the development of technologies such as voice interaction and image recognition, the user 10 can command the system by a voice command or a gesture command without using a physical input device such as the controller 20. For example, the user 10 uses a voice recognition function of the proposal device 100 to utter commands such as “search for a movie”, “open a game app”, and “want to transmit a message to another user”, so that the app can be started or an interaction with another user can be attempted.

However, there are various problems in order to make user 10 utilize the voice command in the system. In general, in order for the system to recognize a voice command, it is necessary for the user 10 to utter a keyword or wording for being recognized as a command. Even if these are described in a manual, a help page, or the like of the system, the user 10 does not necessarily check the keyword or the like. Therefore, even if the system includes highly convenient input means such as a voice command, there is possibility that the user 10 does not sufficiently utilize these means.

Furthermore, even if the system notifies on the screen that the voice command is available, if the user 10 is not interested in the usefulness of using the command, the user cannot be motivated to try the voice command. Furthermore, if the system performs the notification frequently, operability and comfort of the system itself are deteriorated, which may cause dissatisfaction of the user 10.

That is, in proposing the use of the voice command, it is desirable that the target to be proposed be an input means having a high utility value for the user 10 and be executed by a method that does not hinder the use of the system by the user 10.

Therefore, the proposal device 100 according to the present disclosure solves the above problem by the following processing. That is, in a case where a first command (for example, a command using the controller 20 as an input means) input by the user 10 to the system is acquired, the proposal device 100 proposes the use of a second command (for example, a voice command) using the input means different from the first command to the user 10 based on a usage history of the user 10 with respect to the system.

For example, the proposal device 100 determines that the user 10 is a user who frequently uses a search app using the first command based on the usage history. In this case, the proposal device 100 proposes a voice command for causing the user 10 to execute the search app. As described above, the proposal device 100 dynamically determines a voice command that is assumed to be highly convenient when used by the user 10, and proposes the voice command to the user 10 in a proactive aspect. As a result, the proposal device 100 can positively teach the user 10 the useful function such as the voice command provided in the system but not sufficiently used by the user 10. As a result, the proposal device 100 can improve usability related to the system.

Hereinafter, an overview of the proposal processing according to the embodiment will be described using the example illustrated in FIG. 1. The example of FIG. 1 illustrates a status in which user 10 searches for a movie named “XXXX” using the controller 20. For example, the movie “XXXX” is a moving image stored in the system or acquirable by the system via a network. In this case, when accepting the search command via the controller 20, the proposal device 100 starts an app (hereinafter, the app is referred to as an “entire search app”) that exhaustively searches for files and data available in the system, and executes processing of searching for the movie.

At this time, the proposal device 100 checks whether or not the user 10 has already used the voice command for executing the entire search app. Further, the proposal device 100 refers to the usage history such as the execution frequency of the user 10 of the entire search app other than the voice command. Then, the proposal device 100 determines whether or not to propose a voice command to the user 10 depending on whether or not the usage history satisfies a predetermined condition (Step S10).

Although details regarding the determination processing will be described later, in the example of FIG. 1, the user 10 is assumed to be a user who frequently uses the entire search app on a daily basis but does not use a voice command for executing the entire search app. In this case, the proposal device 100 proposes a voice command to the user 10 as input means substituting for the controller 20.

When determining that the voice command should be proposed to the user 10, the proposal device 100 displays a proposal card 32 on, for example, a portal page 30 of the system. For example, the proposal device 100 displays the proposal card 32 at a predetermined time such as at a point in time when the search is performed by the controller operation, at a point in time when the user 10 opens the portal page 30, and at a point in time when the user 10 restarts the system.

The proposal card 32 is an example of a notification means when the system notifies the user 10 of information, and is, for example, an icon indicating a proposal content to the user 10. In the example of FIG. 1, the proposal card 32 includes a keyword for executing the entire search app such as “Find”, and a picture, an animation, or a sentence prompting use of a voice command.

At this time, the proposal device 100 may automatically generate a sentence related to the proposal such that a target (object) of “Find” becomes “XXXX” in the proposal card 32. For example, the proposal device 100 extracts “XXXX” which is a word that the user 10 intends to search with the controller 20, and sets the extracted word as a target of “Find” to generate the sentence.

The user 10 can confirm that the command using the controller 20 can be substituted by a voice command by visually recognizing the proposal card 32 displayed on the portal page 30. In addition, since the user 10 is a user who frequently uses the entire search app, it can be said that the probability of using such a voice command is high.

In this manner, the proposal device 100 proposes another command that can be a substitute means of input on the basis of the usage history of the user 10 in the system. As a result, the proposal device 100 can appropriately teach the user 10 an input means having high utility value for the user 10.

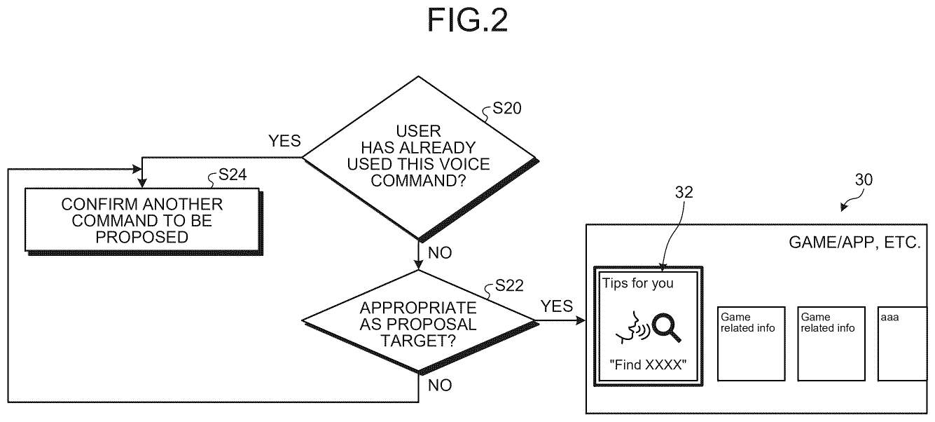

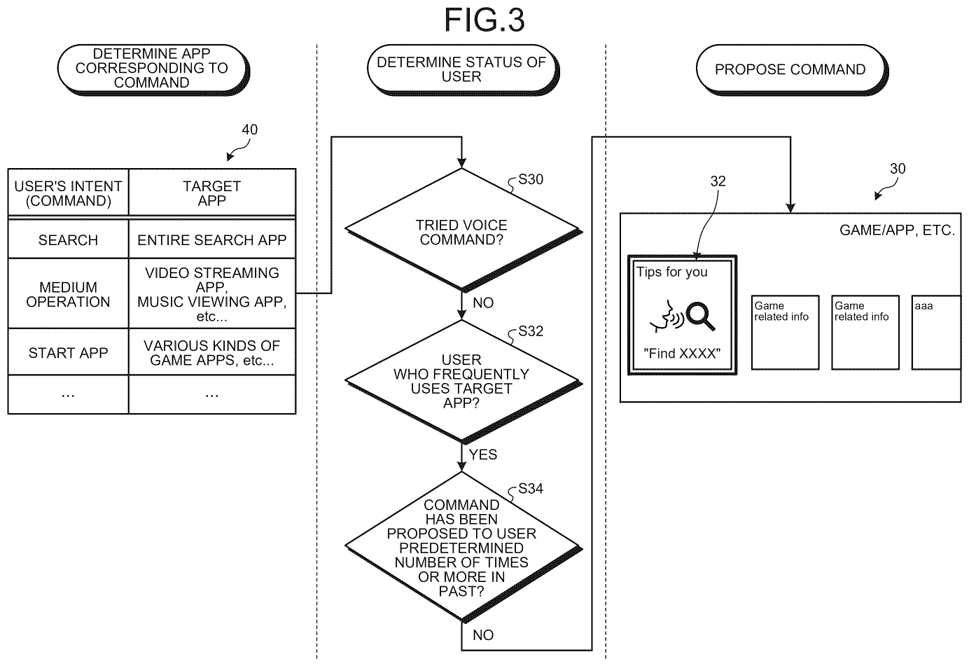

Next, an example of determination processing when the proposal device 100 proposes a voice command to the user 10 will be described with reference to FIGS. 2 and 3. FIG. 2 is a diagram (1) for explaining the proposal processing according to the embodiment.

When acquiring the first command from the user 10, the proposal device 100 determines whether or not there is the second command (voice command) for executing the same processing as that of the first command. Then, in a case where there is a voice command, the proposal device 100 determines whether or not the user 10 has already used the voice command (Step S20).

In a case where the user 10 does not use the voice command (Step S20; No), the proposal device 100 determines whether or not the voice command is appropriate as a proposal target (Step S22). Details of the determination processing will be described later with reference to FIG. 3.

Then, if the proposal device 100 determines that the voice command is appropriate as the proposal target (Step S22; Yes), the proposal device 100 displays the proposal card 32 indicating the voice command to be proposed on the portal page 30 or the like.

Note that, in a case where the user 10 has already used the voice command (Step S20; Yes), or in a case where it is determined that the voice command is not appropriate as the proposal target (Step S22; No), the proposal device 100 does not propose the voice command to the user 10 and confirms another command to be proposed (Step S24).

Next, an example of a procedure of determination processing when the proposal device 100 proposes a voice command to the user 10 will be described with reference to FIG. 3. FIG. 3 is a diagram (2) for explaining the proposal processing according to the embodiment.

In proposing the voice command, the proposal device 100 holds a data table 40 illustrated in FIG. 3, for example, and defines in advance intent of the command of the user 10 and the corresponding app (functions of the system such as execution program). In this example, an app corresponding to the intent of the command is referred to as a “target app”

For example, when the user 10 executes search processing by controller operation, the intent corresponds to “search”. In this case, the proposal device 100 refers to the data table 40 and determines that the target app corresponding to the intent of “search” is the “entire search app”. Subsequently, the proposal device 100 acquires a usage history such as whether or not there is a voice command corresponding to the entire search app, and if there is, how frequently the user 10 uses the voice command. In this manner, the proposal device 100 can set a target app or function in advance for each intent of the user and determine whether or not the user is an active user of the app or function, thereby characterizing the proposed voice command.

When a voice command that is a candidate to be proposed to the user 10 is specified on the basis of the data table 40, the proposal device 100 determines whether or not the user 10 has tried the voice command (Step S30). If the user 10 has tried the voice command, the proposal device 100 determines not to propose the voice command at the present time.

In a case where the user 10 has not tried the voice command (Step S30; No), the proposal device 100 determines whether or not the user 10 is a user who frequently uses the target app (Step S32). For example, the proposal device 100 determines whether or not the user 10 corresponds to a user who starts the target app at least once a week (referred to as a weekly active user or the like). Then, for example, in a case where the user uses the target app more frequently than the weekly active user, the proposal device 100 determines that the user 10 is a user who frequently uses the target app. Note that such a determination criterion can be arbitrarily set by an administrator or the like of the proposal device 100.

If the user 10 is a user who does not use the “entire search app” in the first place, even if the voice command is proposed to the user 10, it is assumed that the utility value of the command is low for the user 10. In this case, the proposal device 100 determines that the proposal of the voice command is not appropriate and does not propose the voice command at this time.

On the other hand, in a case where the user 10 is a user who frequently uses the target app (Step S32; Yes), the proposal device 100 further determines whether the voice command has been proposed to the user 10 a predetermined number of times or more in the past (Step S34). If the search is performed by the user 10 using the controller operation this time again in a state where the voice command has already been proposed to the user 10 several times, it is assumed that the user 10 prefers the controller operation to the voice command with respect to the search. In this case, the proposal device 100 determines that the proposal of the voice command is not appropriate and does not propose the voice command at this time.

On the other hand, in a case where the voice command has not been proposed to the user 10 a predetermined number of times or more in the past (Step S34; No), the proposal device 100 displays the proposal card 32 on the portal page 30.

As described above, the proposal device 100 may include a mechanism for defining condition information (setting of the target app, etc.) corresponding to the intent of the user in advance. As a result, even when a new voice command is added in the future by, for example, system update or the like, the proposal device 100 does not need to set the determination condition again as long as the intent of the command is defined, and thus, it is possible to promote recognition of the new voice command at low cost.

Note that although FIGS. 1 to 3 illustrate an example in which the proposal device 100 proposes a voice command, the command indicating a command to the proposal device 100 is not limited to a voice, and can be performed by text, a gesture, a line of sight, a brain wave signal, or the like. That is, the proposal device 100 may propose the second command using not only a voice but also a text, a gesture, a line of sight, a brain wave signal, and the like to the user 10 as the input means.

### (1-2. Configuration of Proposal Device According to Embodiment)

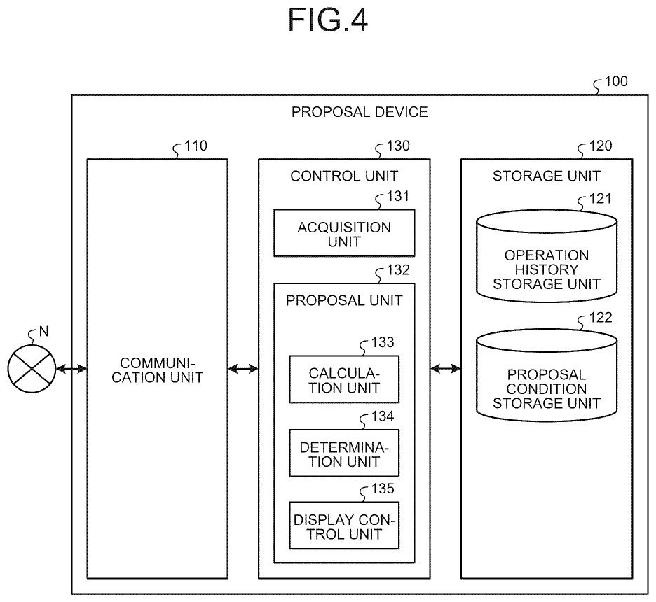

Next, a configuration of the proposal device 100 will be described. FIG. 4 is a diagram illustrating a configuration example of the proposal device 100 according to the embodiment.

As illustrated in FIG. 4, the proposal device 100 includes a communication unit 110, a storage unit 120, and a control unit 130. Note that the proposal device 100 may include an input unit (for example, a keyboard, a touch display, or the like) that receives various operations from an administrator who manages the proposal device 100, the user 10, and the like, and a display unit (for example, a liquid crystal display or the like) for displaying various types of information.

The communication unit 110 is implemented by, for example, a network interface card (NIC), a network interface controller, or the like. The communication unit 110 is connected to the network N in a wired or wireless manner, and transmits and receives information to and from the controller 20, an external device, and the like via the network N. The network N is realized by, for example, a wireless communication standard or system such as Bluetooth (registered trademark), the Internet, Wi-Fi (registered trademark), UWB (Ultra Wide Band), or LPWA (Low Power Wide Area).

The storage unit 120 is implemented by, for example, a semiconductor memory element such as a random access memory (RAM) or a flash memory, or a storage device such as a hard disk or an optical disk.

The storage unit 120 stores various types of information for performing the proposal processing according to the embodiment. Furthermore, the storage unit 120 stores programs such as apps that function in the system, and various data used for processing. In the embodiment, an operation history storage unit 121 and a proposal condition storage unit 122 are exemplified as the storage unit 120.

The operation history storage unit 121 stores an operation history of the user 10 in the system. For example, the operation history storage unit 121 stores the date and time, the number of times, the using time, and the like when the user 10 starts or uses the app. Furthermore, the operation history storage unit 121 stores various action histories of the user 10 such as a history of the user 10 of searching for other users in the system, a history of the user 10 of searching for or viewing a moving image, a game, or the like, and a time.

The proposal condition storage unit 122 stores a condition when the proposal device 100 proposes the second command that can be a substitute means of the first command to the user 10. For example, the proposal condition storage unit 122 corresponds to the data table 40 illustrated in FIG. 3.

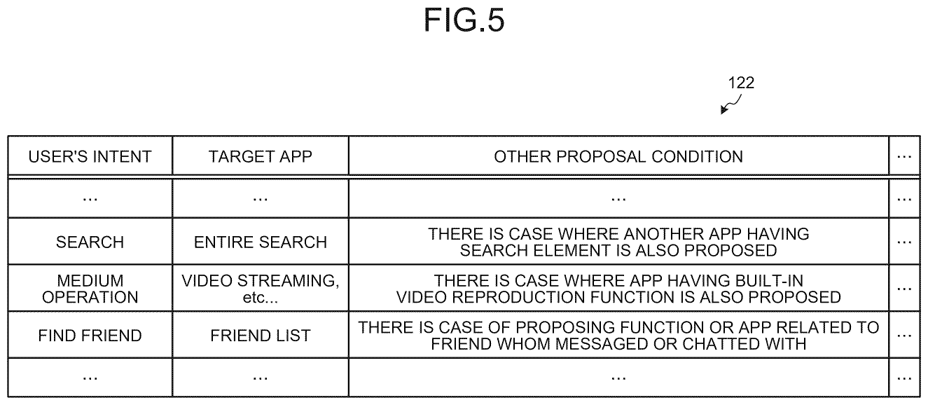

FIG. 5 illustrates an example of information held in the proposal condition storage unit 122. FIG. 5 is a diagram illustrating an example of the proposal condition storage unit 122 according to the embodiment. As illustrated in FIG. 5, the proposal condition storage unit 122 includes items such as “user's intent”, “target app”, and “other proposal condition”.

The “user's intent” indicates an intent of a command that the user 10 wishes to cause the system to execute. The “target app” indicates an app or a function associated with the intent.

The “other proposal condition” indicates a condition to be referred to when the proposal device 100 proposes an app other than the target app. In the system, even if the user 10 is a user who does not frequently use the entire search app as a function of the system, there is a case where the frequency of using is high in using the “search function” as a function in another app (for example, a net shopping app or the like). In such a case, if a voice command is available in another app similarly to the target app, it is useful to propose a voice command for causing the user 10 to execute the search function. Therefore, even if the use frequency of the target app by the user 10 is low, in a case where a condition that “there is a case where another app having a search element is also proposed” is defined as “search” as illustrated in FIG. 5, the proposal device 100 may propose a voice command related to the search to the user 10. Note that, in this case, the proposal device 100 may propose a voice command for starting the shopping app instead of the voice command related to the search. Such determination processing using the “other proposal condition” can occur in the processing procedure of Step S24 illustrated in FIG. 2, for example.

Returning to FIG. 4, the description will be continued. The control unit 130 is implemented by, for example, a central processing unit (CPU), micro processing unit (MPU), GPU, or the like to cause a program stored in the proposal device 100 (for example, a proposal program according to the present disclosure) to be executed on a random access memory (RAM) or the like as a work area. In addition, the control unit 130 is a controller and may be implemented by, for example, an integrated circuit such as an application specific integrated circuit (ASIC) or field programmable gate array (FPGA).

As illustrated in FIG. 4, the control unit 130 includes an acquisition unit 131 and a proposal unit 132. Further, the proposal unit 132 includes a calculation unit 133, a determination unit 134, and a display control unit 135.

The acquisition unit 131 acquires various types of information. For example, the acquisition unit 131 acquires information input to the system by the user 10, a usage history of the user 10 in the system, and the like.

For example, the acquisition unit 131 acquires the first command input by the user 10 to the system. In the embodiment, the first command indicates an intent of the user 10 to cause the system to execute processing, and is a command in which another input means such as voice exists as an input means to the system.

Specifically, the acquisition unit 131 acquires the first command input by means other than voice input, such as operation by the controller 20. In this case, the proposal unit 132 to be described later proposes a voice command to the user 10 as a second command in place of the first command.

Similarly, the acquisition unit 131 may acquire the first command input by means other than gesture input, such as operation by the controller 20. In this case, the proposal unit 132 can propose a command using gesture input to the user 10 as the second command in place of the first command.

In a case where the first command is acquired by the acquisition unit 131, the proposal unit 132 proposes the use of the second command using the input means different from the first command to the user 10 on the basis of the usage history of the user 10 with respect to the system. The proposal unit 132 includes a calculation unit 133, a determination unit 134, and a display control unit 135, and executes the proposal processing according to the embodiment by controlling each processing unit. The calculation unit 133 executes various calculations such as calculation of a score in a proposed algorithm to be described later. The determination unit 134 determines whether or not to propose the second command to the user 10 on the basis of the score calculated by the calculation unit 133. In a case where the determination unit 134 determines to propose the second command to the user 10, the display control unit 135 performs control to display (notify) the proposal in an appropriate mode according to a display mode of an app or the like that displays the proposal.

As an example, the proposal unit 132 determines whether or not to propose the use of the second command to the user 10 on the basis of the usage history of the user 10 regarding the processing executed by the first command or the second command. For example, in a case where the processing executed by the first command or the second command is the search function, if the user 10 is a user who frequently uses the search function, the proposal unit 132 can determine to actively propose since the utility value of the voice command related to the search is high for the user 10. On the other hand, in a case where the user 10 is a user who hardly uses the search function, the proposal unit 132 can determine that the voice command related to the search is not proposed because the proposal is not useful.

That is, the proposal unit 132 can propose a command associated with the first command in advance to the user 10 as the second command. For example, the proposal unit 132 refers to the proposal condition storage unit 122 and determines that the second command that is the search by the voice input on the basis of the search function is associated with the first command that is the search by the controller operation, for example. In this case, the proposal unit 132 can propose a search method by a voice command to the user 10 who has performed the search by the controller operation.

At this time, the proposal unit 132 may determine whether or not to propose the use of the second command to the user 10 on the basis of the usage history of the user 10 regarding the processing executed by the system on the basis of the first command. For example, the proposal unit 132 determines whether or not to propose use of the second command to the user 10 on the basis of the number of times or frequency of inputting the first command by the user 10.

Furthermore, the proposal unit 132 may propose the use of the second command to the user 10 in a case where the use of the second command has not been proposed to the user 10 in the past or a predetermined period has elapsed since the use of the second command has been proposed to the user 10 in the past. Specifically, the proposal unit 132 can adjust the interval of the predetermined period according to the number of times the first command is input by the user and the history of proposing the use of the second command to the user 10.

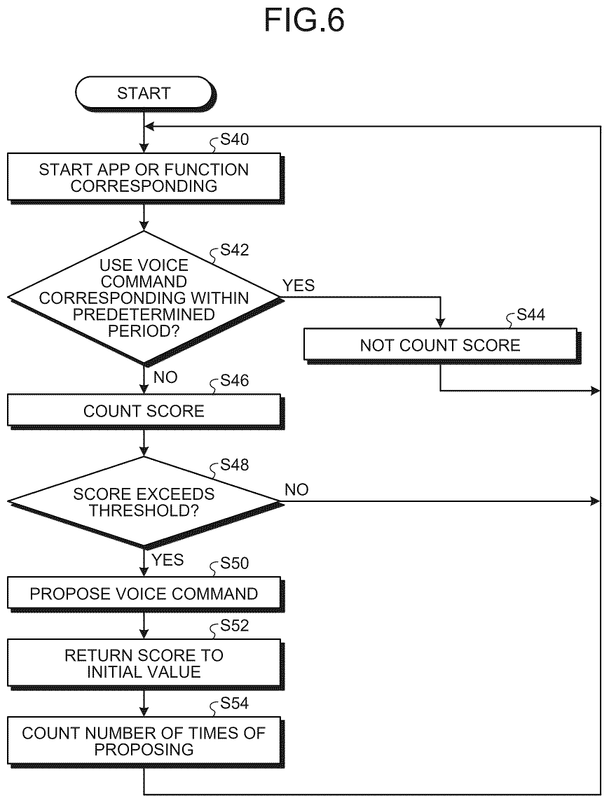

In the above processing, the proposal unit 132 may calculate a score by predetermined calculation processing and determine whether or not to propose the use of the second command to the user 10 on the basis of the score. Such processing will be described with reference to FIG. 6.

FIG. 6 is a flowchart illustrating an example of a procedure of the proposal processing according to the embodiment. In the example illustrated in FIG. 6, a description will be given on processing in which the proposal device 100 calculates a score serving as a trigger for proposing a voice command on the basis of the usage history of the user 10 and proposes the voice command when the score exceeds a threshold. In this case, by adjusting the interval after once proposing the voice command, the proposal device 100 can also suppress a situation in which the proposal is displayed more frequently than the user 10 desires (referred to as “spamming” or the like).

The process of the proposal processing will be described with reference to FIG. 6. First, when acquiring the first command from the user 10, the proposal device 100 starts an app or a function corresponding to the first command (Step S40).

At this time, the proposal device 100 determines whether or not there is a history that the user 10 uses the voice command corresponding to the app or the like started in Step S40 within a predetermined period (Step S42). Note that the predetermined period can be arbitrarily set by the proposal device 100. For example, in a case where it is intended to make a proposal to a user who has not used the voice command for one month or more, the proposal device 100 sets the predetermined period to one month. Alternatively, in a case where it is intended not to make a proposal to a user who has used the voice command even once in the past, the proposal device 100 may set the predetermined period as an indefinite period.

In a case where the user 10 uses the corresponding voice command within the predetermined period (Step S42; Yes), since it is not necessary to perform the proposal processing, the proposal device 100 continues the processing of the app without counting the score (Step S44).

On the other hand, in a case where the user 10 does not use the corresponding voice command (Step S42; No), the proposal device 100 counts the operation of the first command by the user 10 (input by the controller 20, etc.) once (Step S46).

The proposal device 100 calculates a score for making a proactive proposal on the basis of the following Formula (1), for example.

$$S = s + 1 / ( Pn + 1 ) \qquad ( 1 )$$

The above Formula (1) indicates that 1 is added to the previous score S as an operation of the variable (score S) on the left side. Furthermore, “Pn” indicates the number of times the system has made proposals (the proactive proposal processing has been activated). In the initial state, the score S and the number of proposals Pn are “0”.

After counting the score in Step S46, the proposal device 100 determines whether the score S exceeds the threshold (Step S48). In a case where the score S does not exceed the threshold (Step S48; No), since it is not necessary to perform the proposal processing, the proposal device 100 continues the processing of the app without counting the score.

On the other hand, in a case where the score S exceeds the threshold (Step S48; Yes), the proposal device 100 activates the proactive processing and proposes a voice command (Step S50). For example, assuming that the number of proposals Pn is 0 and the threshold is set to “2” in the initial state, a voice command is proposed to the user 10 in a case where the user 10 performs the controller operation twice.

If the voice command is proposed, the proposal device 100 returns the score S to the initial value (Step S52). At this time, the proposal device 100 counts the number of times of proposing the voice command (Step S54). That is, the proposal device 100 increases the number of proposals Pn in the above Formula (1). Note that a numerical value set as the number of proposals Pn can be arbitrarily set by the proposal device 100. As a result, once the proposal device 100 proposes the voice command to the user 10, it is possible to extend the interval to propose the voice command. That is, by adjusting the frequency at which the voice command is proposed to the user 10, the proposal device 100 can suppress proposal spamming.

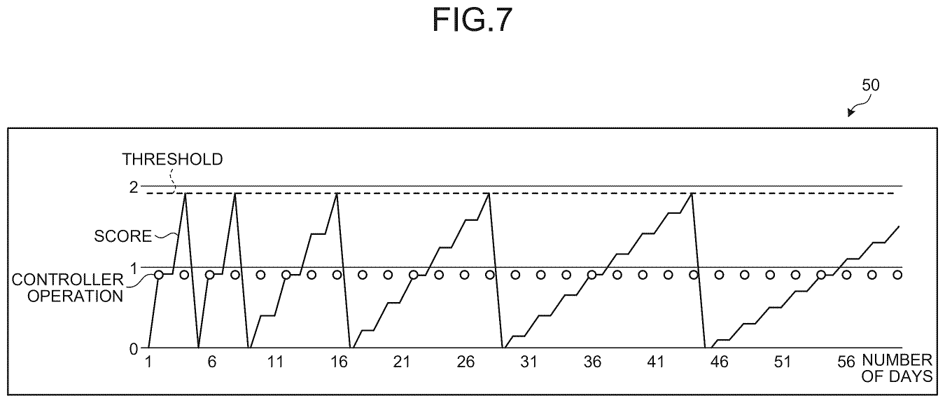

FIG. 7 illustrates a frequency at which the proposal device 100 makes a proposal. FIG. 7 is a diagram conceptually illustrating a frequency of proposal processing according to the embodiment.

In a graph 50 illustrated in FIG. 7, the vertical axis represents the operation history of the user 10, and the horizontal axis represents time (for example, the number of days). As illustrated in the graph 50, in the initial state, the score S reaches the threshold only by the user 10 performing the controller operation twice. Specifically, when the user 10 performs the search processing twice using the controller operation, the proposal device 100 proposes a voice command corresponding to the search to the user 10. Thereafter, as the number of proposals increases, the proposal by the proposal device 100 is less likely to be displayed even if the user 10 performs the controller operation. That is, the proposal device 100 adjusts the frequency at which proposals are made by dynamic control. With this configuration, the proposal device 100 can avoid a situation where the user 10 feels annoyed that the proposal is frequently displayed in a short period of time.

Note that the arithmetic expression of the score S illustrated in FIGS. 6 and 7, the setting of the predetermined period, the setting of the threshold, and the like can be arbitrarily set by the administrator or the like of the proposal device 100. For example, the administrator of the proposal device 100 may set a different arithmetic expression or threshold value for each app (function).

Returning to FIG. 4, the description will be continued. The proposal unit 132 may propose, as a second command, a command for a second program different from a first program (app or the like) in which processing is executed on the basis of a first command, the command causing the second program to execute processing related to the content of the first command, to the user 10. For example, the proposal unit 132 refers to another proposal condition held in the proposal condition storage unit 122, and can propose a command described in the condition when the condition is met. Specifically, it is assumed that the controller operation by the user 10 is not for the entire search app (corresponding to the above first program) in the system but for the search of the shopping app (the above second program). In this case, the proposal device 100 can propose a voice command related to the search in the shopping app (the “command causing the second program to execute” described above) to the user 10 on the basis of the condition setting that associates the entire search app with the search for the shopping app.

Note that the above processing is not necessarily executed on the basis of a data table defined in advance, and may be executed on the basis of machine learning or the like. For example, the proposal device 100 determines similarity between the first program and the second program using a learned model in which attributes, actions, operation histories, and the like of users in the first program and the second program are learned. Then, the proposal device 100 may specify the voice command to be proposed on the basis of the similarity between the programs. As an example, when determining that the similarity between the operation in the entire search app and the search processing in the shopping app is high, the proposal device 100 can propose a common voice command to the user 10. As described above, the proposal device 100 may specify the second command to be proposed by not necessarily rule-based processing but dynamic processing based on machine learning or the like.

In addition, the proposal unit 132 may set a predetermined target that can be a target of the second command based on a usage history of the user 10 in the system when proposing the use of the second command, and propose the second command together with the predetermined target. For example, the proposal unit 132 sets, as the predetermined target, content the user 10 viewed or operated in the past in the system. More specifically, the proposal unit 132 sets, as the predetermined target, a name of content the user 10 viewed or a name of a game the user 10 operated in the past in the system.

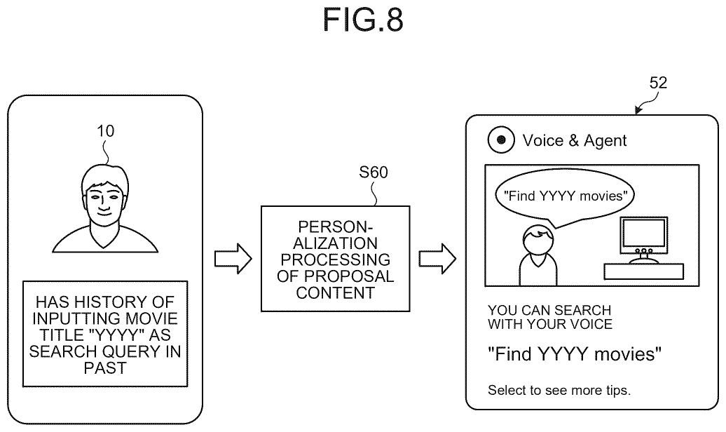

These processes will be described with reference to FIG. 8. FIG. 8 is a diagram (1) illustrating a variation of proposal processing according to the embodiment.

For example, it is assumed that the user 10 has a history of inputting a movie title “YYYY” as a search query in the past. Thereafter, in a case where the first command for performing some sort of search processing is acquired, the proposal unit 132 performs personalization processing of proposal content in order to give an effective proposal to the user 10 (Step S60).

For example, the proposal unit 132 displays not only “Find” as the voice command related to the search but also “YYYY” as a target of the voice command, which is a proposal card 52 including a name based on the usage history of the user 10.

That is, the proposal unit 132 proposes the voice command in a format related to the activity of the user 10 himself/herself instead of the fixed proposal display. As a result, the proposal device 100 can further convey the usefulness of using the voice command to the user 10, and can improve the closeness of the user 10 to the voice command, so that the use probability of the voice command can be increased.

Note that the proposal unit 132 may set not only the content but also various contents as the predetermined target. For example, the proposal unit 132 may set another user determined to have a friendship with the user 10 in the system as the predetermined target.

For example, in a case where the user 10 frequently performs voice chat with a user named “FFF”, the proposal unit 132 sets “FFF” as a target of “Voice chat” which is a voice command corresponding to a voice chat start command. In this case, the proposal unit 132 displays a proposal card on which a display such as “Voice chat with FFF!” is made. As a result, the proposal unit 132 can make a proposal displayed to give the user 10 a sense of closeness.

Furthermore, as another example, in a case where the user 10 frequently plays a game named “GGG”, the proposal unit 132 sets “GGG” as a target of “Start” that is a voice command corresponding to a command to start game play. In this case, the proposal unit 132 displays a proposal card on which a display such as “Start GGG!” is made. As a result, the proposal unit 132 can make a proposal displayed to give the user 10 a sense of closeness.

As another example, in a case where the frequency at which the user 10 performs network setting in the system is high, the proposal unit 132 sets “network setting” as a target of “Go” that is a voice command corresponding to a command to move to a setting item in the system. In this case, the proposal unit 132 displays a proposal card on which a display such as “Go to Network Setting” is made. As a result, the proposal unit 132 can make the user aware of the usefulness of being able to quickly perform an operation that is frequently performed by using the voice command.

Furthermore, as another example, the proposal unit 132 may generate a predetermined target on the basis of actions or the like in the app, not limited to the app or the like started by the user 10. For example, it is assumed that user 10 frequently browses downloadable contents (DLC) in a game named “GGG”. In this case, the proposal unit 132 displays a proposal card on which a display such as “Find DLC of GGG” is made as a target of “Find” which is a voice command related to search on the basis of the action history. As a result, the proposal unit 132 can make a proposal that gives a stronger closeness based on the action of the user 10.

Furthermore, as another example, the proposal unit 132 may generate a predetermined target by associating an app or the like started by the user 10 with another user or the like connected to the user 10. For example, it is assumed that the user 10 frequently plays with a user named “FFF” in a game named “GGG”. In this case, the proposal unit 132 displays a proposal card on which a display such as “Play GGG with FFF” is made as a target of “Play” which is a voice command related to the game play on the basis of the action history. As a result, the proposal unit 132 can make a proposal that gives a stronger closeness based on the action of the user 10.

Furthermore, as another example, the proposal unit 132 may generate the predetermined target on the basis of the attribute of the content instead of the content itself viewed by the user 10. For example, it is assumed that the user 10 frequently views an action-related movie or video. In this case, the proposal unit 132 displays a proposal card on which a display such as “Find action movies” is made as a target of “Find” which is a voice command related to search on the basis of the action history. As a result, the proposal unit 132 can propose a voice command that matches the action of the user 10 and makes the user 10 think that the value of use is high.

The automatic generation of the sentence as illustrated in FIG. 8 and the like may be executed in a rule-based manner, or may be executed using a machine learning model learned with an action history (start operation of app, actions in app, and the like) by the user 10 as learning data. In the machine learning, for example, a known method or the like for generating a learning model for automatically generating a sentence can be used.

Furthermore, when proposing the use of the second command, the proposal unit 132 may notify the user 10 of an advantage in the system in a case where the user 10 uses an input means corresponding to the second command. For example, the proposal unit 132 notifies the user 10 of a processing speed in the system in a case where the user 10 uses an input means corresponding to the second command as compared with a case where an input means corresponding to the first command is used. In addition, the proposal unit 132 may display when proposing the use of the second command, a usage status of the user 10 for another command using an input means corresponding to the second command.

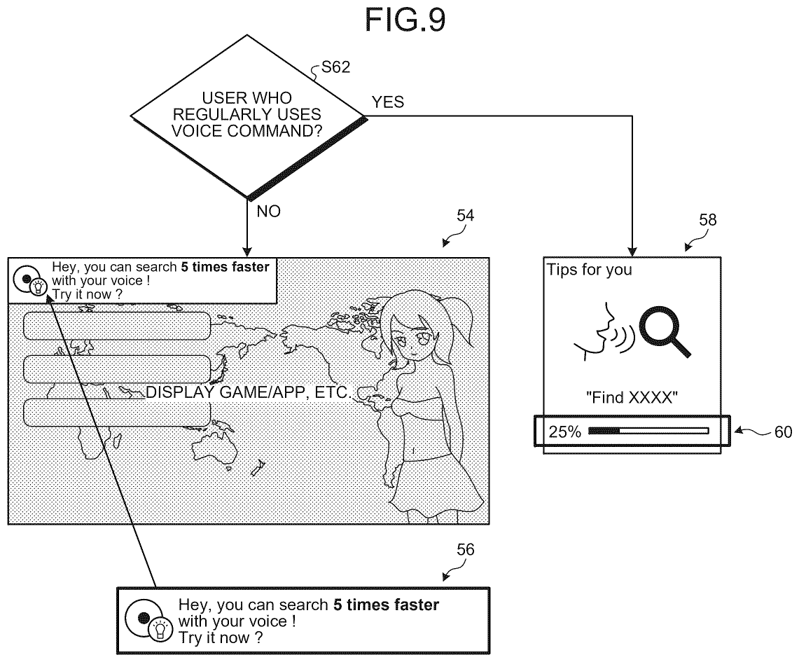

These processes will be described with reference to FIG. 9. FIG. 9 is a diagram (2) illustrating a variation of proposal processing according to the embodiment.

In the example illustrated in FIG. 9, when making a proposal, the proposal unit 132 determines whether or not the user 10 is a user who regularly uses a voice command (Step S62). In a case where the user 10 is not a user who regularly uses the voice command (Step S62; No), the proposal unit 132 notifies the user 10 of the advantage of using the voice command as the proposal.

A game screen 54 illustrated in FIG. 9 illustrates a screen on which a proposal by the system is notified. For example, a notification 56 is displayed on the upper portion of the game screen 54 in a manner to be overlaid on the game screen. For example, in a case where the user 10 selects a game character or a game item by performing a controller operation on the game screen 54, the proposal unit 132 proposes a voice command as a means for substituting such an operation.

At this time, the notification 56 includes a message that the processing can be done several times faster with the voice command as compared with a case where the user 10 performs the controller operation to select a game character. For example, the proposal unit 132 compares the average operation speed in the voice command with the operation speed at which the user 10 performs the controller operation and selects the game character, and generates a message using the result. As a result, the proposal unit 132 can notify the user 10 of the usefulness of the substitute voice command, and can increase the use probability of the voice command.

On the other hand, in a case where the user 10 is a user who regularly uses the voice command (Step S62; Yes), the proposal unit 132 notifies the user 10 of the proposal including information promoting use of another voice command as the proposal.

A proposal card 58 illustrated in FIG. 9 includes a voice command usage rate 60. The voice command usage rate 60 indicates a ratio of the number of voice commands used by the user 10 among the voice commands included in the system. By performing such display, the proposal unit 132 can motivate the user 10 to more actively use the voice command.

Note that the proposal unit 132 can proposes, as a proposal mode, the use of the second command using any means of icon display on a portal page of the system, in-screen notification during execution of a program in the system, and sound output from the system.

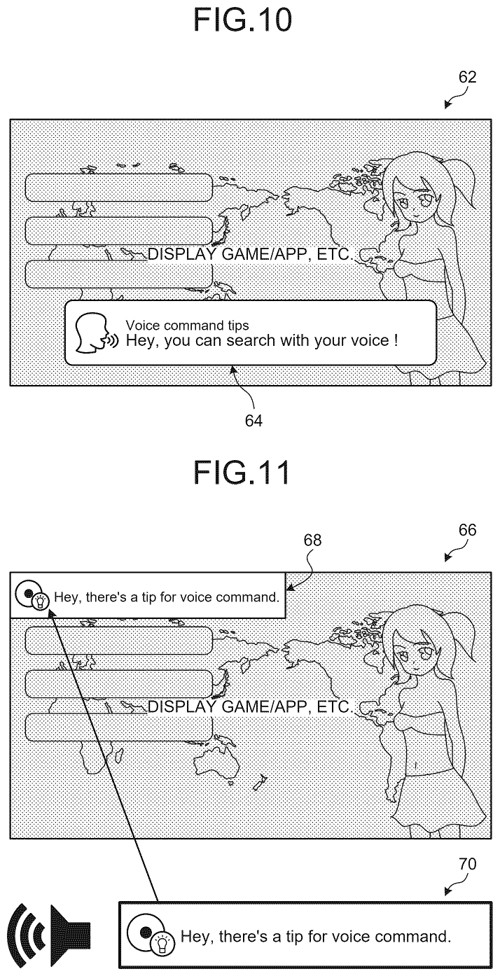

These processes will be described with reference to FIGS. 10 and 11. FIG. 10 is a diagram (3) illustrating a variation of proposal processing according to the embodiment.

FIG. 10 illustrates an example in which the proposal unit 132 displays a notification 64 superimposed on a game screen 62. In this manner, the proposal unit 132 can make the user 10 recognize the voice command more actively by showing the proposal in a mode such as a push notification.

FIG. 11 is a diagram (4) illustrating a variation of proposal processing according to the embodiment. FIG. 11 illustrates an example in which the proposal unit 132 outputs the content of a notification 70 with sound on a game screen 66. In this case, the proposal unit 132 may display a notification 68 in which the content of the message of the notification 70 is indicated by text or the like at the end of the game screen 66. In this manner, the proposal unit 132 can make the user 10 who is not viewing the screen recognize the voice command by indicating the proposal to the user 10 with sound.

### (1-3. Modification)

### (1-3-1. Device Configuration)

The proposal device 100 according to the embodiment merely conceptually illustrates functions, and can take various aspects according to the embodiment. For example, the proposal device 100 may include two or more devices different for each function described above. As an example, the proposal device 100 may include a cloud server and an edge terminal (a smart speaker, a smartphone, or the like) connected via a network. In this case, when the edge terminal obtains the first command from the user 10, the edge terminal sends the obtained information to the cloud server. Then, the cloud server performs processing as illustrated in FIG. 1 and the like, and performs control to display a proposal such as a voice command on the edge terminal.

### (1-3-2. Input to System)

In the above embodiment, the example in which the proposal device 100 receives some command input from the user 10 has been described. Here, the command input does not necessarily involve execution of information processing by the system, and may be any input of some information to the system. Furthermore, the input target is not limited to the user or the app name, and may be arbitrary information such as an item or a character in the game content.

### (1-3-3. System Aspects)

In the above embodiment, an example has been described in which the system that proposes a voice command or the like is an operating system. However, the system is not limited to an operating system. For example, the system may be various kinds of apps or the like. That is, in a case where the app has a function as an information processing system that performs search processing in the app or processing of activating a game or the like held in the app, the proposal processing according to the embodiment may be applied to a system such as the app. In addition, the screen on which the proposal is displayed in the system is not limited to the portal page or the like, and may be any user interface.

### 2. Other Embodiments

The processing according to the above-described embodiment may be implemented in various different modes other than the above-described embodiment.

In addition, among the processing described in the above embodiments, all or a part of the processing, described as automatic processing, can be performed manually, or all or a part of the processing, described as manual processing, can be performed automatically by a known method. In addition, the processing procedures, specific names, and information including various data and parameters indicated in the above document and the drawings can be arbitrarily changed unless otherwise specified. For example, various types of information illustrated in the drawings are not limited to the illustrated information.

Furthermore, the constituent elements of the individual devices illustrated in the drawings are functionally conceptual and are not necessarily configured physically as illustrated in the drawings. To be specific, the specific form of distribution and integration of the devices is not limited to the one illustrated in the drawings, and all or a part thereof can be configured by functionally or physically distributing and integrating in any units according to various loads, usage conditions, and the like. For example, the calculation unit 133 and the determination unit 134 may be integrated.

Furthermore, the above-described embodiments and modifications can be appropriately combined within a range that the processing contents do not contradict each other.

In addition, the effects described in the present specification are merely examples and are not limited, and other effects may be provided.

### 3. Effects of Proposal Device According to Present Disclosure

As described above, the proposal device according to the present disclosure (the proposal device 100 in the embodiment) includes an acquisition unit (the acquisition unit 131 in the embodiment) and a proposal unit (the proposal unit 132 in the embodiment). The acquisition unit acquires the first command input by the user to the information processing system. In a case where the first command is acquired by the acquisition unit, the proposal unit proposes the use of the second command using the input means different from the first command to the user on the basis of the usage history of the user with respect to the information processing system.

In this manner, the proposal device according to the present disclosure proposes another command that can be a substitute means of input on the basis of the usage history of the user in the system. As a result, the proposal device 100 can appropriately teach the user an input means having high utility value for the user.

In addition, the proposal unit determines whether or not to propose the use of the second command to the user on the basis of the usage history of the user regarding processing executed by the first command or the second command.

In this manner, the proposal device can select only the proposal having the truly high utility value for the user by determining whether or not to propose the second command to the user on the basis of whether or not the user frequently uses the processing executed by the first command or the second command.

Furthermore, the proposal unit proposes the use of the second command to the user in a case where the use of the second command has not been proposed to the user in the past or a predetermined period has elapsed since the use of the second command has been proposed to the user in the past. For example, the proposal unit adjusts the interval of the predetermined period according to the number of times the first command is input by the user and the history of proposing the use of the second command to the user.

As described above, by adjusting the frequency of proposing the second command on the basis of the usage history of the user, the proposal device can suppress a proposal that makes the user feel annoyed and can ensure that the usability of the system is not deteriorated.

Further, the proposal unit proposes a command associated with the first command in advance to the user as the second command. For example, the proposal unit determines whether or not to propose the use of the second command to the user on the basis of the usage history of the user regarding processing executed by the information processing system on the basis of the first command.

As described above, by associating the first command and the second command in advance, the proposal device can execute the proposal processing while maintaining the determination condition even if a new second command is added due to system update or the like.

In addition, the proposal unit proposes, as a second command, a command for a second program different from a first program in which processing is executed on the basis of a first command, the command causing the second program to execute processing related to the content of the first command, to the user.

As described above, the proposal device can propose not only the target app but also an app or the like that executes related processing. As a result, the proposal device can actively propose a voice command or the like in the system that is difficult for the user to notice.

In addition, the proposal unit sets a predetermined target that can be a target of the second command based on a usage history of the user in the information processing system when proposing the use of the second command, and proposes the second command together with the predetermined target. For example, the proposal unit sets, as the predetermined target, content the user viewed or operated in the past in the information processing system. Specifically, the proposal unit sets, as the predetermined target, a name of content the user viewed or a name of a game the user operated in the past in the information processing system. Alternatively, the proposal unit sets another user determined to have a friendship with the user in the information processing system as the predetermined target.

As described above, the proposal device can generate a proposal that makes the user feel a sense of closeness by dynamically changing the content to be displayed in the proposal on the basis of the user's action or the like, thereby improving the use probability of the proposed voice command or the like.

Furthermore, the proposal unit notifies when proposing the use of the second command, the user of an advantage in the information processing system in a case where the user uses an input means corresponding to the second command. For example, the proposal unit notifies the user of a processing speed in the information processing system in a case where the user uses an input means corresponding to the second command as compared with a case where an input means corresponding to the first command is used.

As described above, the proposal device can motivate the user to use the voice command or the like by presenting the advantage of using the voice command or the like to the user.

In addition, the proposal unit displays when proposing the use of the second command, a usage status of the user for another command using an input means corresponding to the second command.

As described above, the proposal device can motivate the user to feel like using more commands by displaying the usage status of the user such as the usage rate of the voice command in the system.

In addition, the proposal unit proposes the use of the second command using any means of icon display on a portal page of the information processing system, in-screen notification during execution of a program in the information processing system, and sound output from the information processing system.

As described above, the proposal device can make the user surely recognize the proposal by making the proposal to the user by various notification methods.

In addition, the acquisition unit acquires the first command input by means other than voice input. The proposal unit proposes the use of the second command using the voice input to the user. Alternatively, the acquisition unit acquires the first command input by means other than the gesture input. The proposal unit proposes the use of the second command using the gesture input to the user.

In this manner, the proposal device can actively propose a command using various input means included in the system, such as voice and gesture, to the user.

### 4. Hardware Configuration

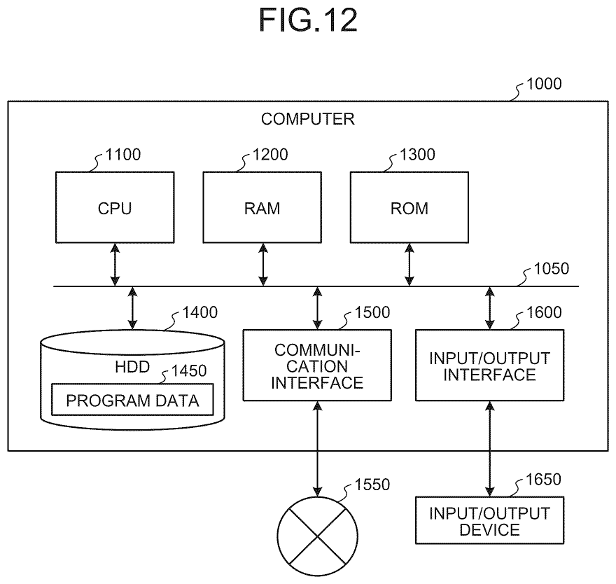

The information device such as the proposal device 100 according to the above-described embodiments is implemented by a computer 1000 having a configuration as illustrated in FIG. 12, for example. Hereinafter, the proposal device 100 will be described as an example. FIG. 12 is a hardware configuration diagram illustrating an example of the computer 1000 that implements functions of the proposal device 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 decompresses a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is started, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records a proposal program according to the present disclosure, which is an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, an speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the proposal device 100 according to the embodiment, the CPU 1100 of the computer 1000 implements the functions of the control unit 130 and the like by executing the proposal program loaded on the RAM 1200. In addition, the HDD 1400 stores the proposal program according to the present disclosure and data in the storage unit 120. Note that the CPU 1100 reads the program data 1450 from the HDD 1400 and executes the program data, but as another example, these programs may be acquired from another device via the external network 1550.

Note that the present technology can also have the following configurations.

(1) A proposal device comprising:
an acquisition unit configured to acquire a first command input by a user to an information processing system; and
a proposal unit configured to propose, in a case where the first command is acquired by the acquisition unit, use of a second command using an input means different from the first command to the user based on a usage history of the user for the information processing system.
   (2) The proposal device according to (1), wherein
the proposal unit determines whether or not to propose the use of the second command to the user based on a usage history of the user regarding processing executed by the first command or the second command.
   (3) The proposal device according to (1) or (2), wherein
the proposal unit proposes the use of the second command to the user in a case where the use of the second command has not been proposed to the user in the past or a predetermined period has elapsed since the use of the second command has been proposed to the user in the past.
   (4) The proposal device according to (3), wherein
the proposal unit adjusts an interval of the predetermined period according to the number of times the first command is input by the user and the history of proposing the use of the second command to the user.
   (5) The proposal device according to any one of (1) to (4), wherein
the proposal unit proposes a command associated in advance with the first command to the user as the second command.
   (6) The proposal device according to (5), wherein
the proposal unit determines whether or not to propose use of the second command to the user based on a usage history of the user regarding processing executed by the information processing system based on the first command.
   (7) The proposal device according to any one of (1) to (6), wherein
the proposal unit proposes, as the second command, a command for a second program different from a first program in which processing is executed based on the first command, the command causing the second program to execute processing related to content of the first command, to the user.
   (8) The proposal device according to any one of (1) to (7), wherein
the proposal unit sets a predetermined target that can be a target of the second command based on a usage history of the user in the information processing system when proposing the use of the second command, and proposes the second command together with the predetermined target.
   (9) The proposal device according to (8), wherein
the proposal unit sets, as the predetermined target, content the user viewed or operated in the past in the information processing system.
   (10) The proposal device according to (9), wherein
the proposal unit sets, as the predetermined target, a name of content the user viewed or a name of a game the user operated in the past in the information processing system.
   (11) The proposal device according to (8), wherein
the proposal unit sets another user determined to have a friendship with the user in the information processing system as the predetermined target.
   (12) The proposal device according to any one of (1) to (11), wherein
the proposal unit notifies when proposing the use of the second command, the user of an advantage in the information processing system in a case where the user uses an input means corresponding to the second command.
   (13) The proposal device according to (12), wherein
the proposal unit notifies the user of a processing speed in the information processing system in a case where the user uses an input means corresponding to the second command as compared with a case where an input means corresponding to the first command is used.
   (14) The proposal device according to any one of (1) to (13), wherein
the proposal unit displays when proposing the use of the second command, a usage status of the user for another command using an input means corresponding to the second command.
   (15) The proposal device according to any one of (1) to (14), wherein
the proposal unit proposes the use of the second command using any means of icon display on a portal page of the information processing system, in-screen notification during execution of a program in the information processing system, and sound output from the information processing system.
   (16) The proposal device according to any one of (1) to (15), wherein
the acquisition unit acquires the first command input by means other than voice input, and
the proposal unit proposes the user to use the second command using voice input.
   (17) The proposal device according to any one of (1) to (15), wherein
the acquisition unit acquires the first command input by means other than gesture input, and
the proposal unit proposes the user to use the second command using gesture input.
   (18) A proposal method causing
a computer to execute the steps of:
acquiring a first command input by a user to an information processing system; and
proposing, in a case where the first command is acquired, use of a second command using an input means different from the first command to the user based on a usage history of the user for the information processing system.

### REFERENCE SIGNS LIST

10 USER
20 CONTROLLER
100 PROPOSAL DEVICE
110 COMMUNICATION UNIT
120 STORAGE UNIT
121 OPERATION HISTORY STORAGE UNIT
122 PROPOSAL CONDITION STORAGE UNIT
130 CONTROL UNIT
131 ACQUISITION UNIT
132 PROPOSAL UNIT
133 CALCULATION UNIT
134 DETERMINATION UNIT
135 DISPLAY CONTROL UNIT

1. A proposal device comprising:
an acquisition unit configured to acquire a first command input by a user to an information processing system; and
a proposal unit configured to propose, in a case where the first command is acquired by the acquisition unit, use of a second command using an input means different from the first command to the user based on a usage history of the user for the information processing system.

2. The proposal device according to claim 1, wherein
the proposal unit determines whether or not to propose the use of the second command to the user based on a usage history of the user regarding processing executed by the first command or the second command.

3. The proposal device according to claim 1, wherein
the proposal unit proposes the use of the second command to the user in a case where the use of the second command has not been proposed to the user in the past or a predetermined period has elapsed since the use of the second command has been proposed to the user in the past.

4. The proposal device according to claim 3, wherein
the proposal unit adjusts an interval of the predetermined period according to the number of times the first command is input by the user and the history of proposing the use of the second command to the user.

5. The proposal device according to claim 1, wherein
the proposal unit proposes a command associated in advance with the first command to the user as the second command.

6. The proposal device according to claim 5, wherein
the proposal unit determines whether or not to propose use of the second command to the user based on a usage history of the user regarding processing executed by the information processing system based on the first command.

7. The proposal device according to claim 1, wherein
the proposal unit proposes, as the second command, a command for a second program different from a first program in which processing is executed based on the first command, the command causing the second program to execute processing related to content of the first command, to the user.

8. The proposal device according to claim 1, wherein
the proposal unit sets a predetermined target that can be a target of the second command based on a usage history of the user in the information processing system when proposing the use of the second command, and proposes the second command together with the predetermined target.

9. The proposal device according to claim 8, wherein
the proposal unit sets, as the predetermined target, content the user viewed or operated in the past in the information processing system.

10. The proposal device according to claim 9, wherein
the proposal unit sets, as the predetermined target, a name of content the user viewed or a name of a game the user operated in the past in the information processing system.

11. The proposal device according to claim 8, wherein
the proposal unit sets another user determined to have a friendship with the user in the information processing system as the predetermined target.

12. The proposal device according to claim 1, wherein
the proposal unit notifies when proposing the use of the second command, the user of an advantage in the information processing system in a case where the user uses an input means corresponding to the second command.

13. The proposal device according to claim 12, wherein
the proposal unit notifies the user of a processing speed in the information processing system in a case where the user uses an input means corresponding to the second command as compared with a case where an input means corresponding to the first command is used.

14. The proposal device according to claim 1, wherein
the proposal unit displays when proposing the use of the second command, a usage status of the user for another command using an input means corresponding to the second command.

15. The proposal device according to claim 1, wherein
the proposal unit proposes the use of the second command using any means of icon display on a portal page of the information processing system, in-screen notification during execution of a program in the information processing system, and sound output from the information processing system.

16. The proposal device according to claim 1, wherein
the acquisition unit acquires the first command input by means other than voice input, and
the proposal unit proposes the user to use the second command using voice input.

17. The proposal device according to claim 1, wherein
the acquisition unit acquires the first command input by means other than gesture input, and
the proposal unit proposes the user to use the second command using gesture input.

18. A proposal method causing
a computer to execute the steps of:
acquiring a first command input by a user to an information processing system; and
proposing, in a case where the first command is acquired, use of a second command using an input means different from the first command to the user based on a usage history of the user for the information processing system.
